(19) United States
(12) Patent Application Publication
(10) Pub. No.: US 2018/0131605 A1
(43) Pub. Date: May 10, 2018

(54) FLOATING INTERNET PROTOCOL FOR PRIVATE NETWORKS

(71) Applicant: SAP SE, Walldorf (DE)

(72) Inventor: SHASHANK MOHAN JAIN, Bangalore (IN)

(21) Appl. No.: 15/348,084

(22) Filed: Nov. 10, 2016

(51) Int. Cl. H04L 12/721; H04L 12/713; H04L 29/12; H04L 12/26; H04L 12/46

(52) U.S. Cl. CPC H04L 45/70; H04L 45/586; H04L 12/4641; H04L 43/0817; H04L 61/2061

(57) ABSTRACT

Various embodiments of systems and methods for handling floating internet protocol (FIP) within private networks are described herein. The method includes sending a request to a private provider network for retrieving a floating internet protocol (FIP) address from a pool_of_FIP addresses stored in the private provider network. Based upon the request, the FIP address is received from the private provider network. The received FIP address is attached to a backend machine including a database. The backend machine is included within another private network.

### BACKGROUND

A private network provides internal network access within an enterprise. The private network may comprise various machines and/or databases. Each machine or database has an internet protocol (IP) address that acts as its identity or access point within the private network. The IP address tied to the machine or database is permanent and cannot he changed dynamically (i.e., permanent IP). Each machine or database handles requests/tasks raised through one or more applications. For example, database1 may handle requests raised through a web application “mydatabase.com.” Typically, the requests from “mydatabase.com” may be directed to the permanent IP address of the database1. A look-up table or a domain name server (DNS) may he maintained to map applications to respective IP addresses of the machines or databases, which handle the requests coming through the respective application. In case of a failover, if a database is down or failed, the look-up table may be configured to route requests to an IP address of another machine. However, a user may need to manually modify or make changes, e.g., in the look-up table, which may be an arduous task.

Often, a floating IP address may be used to eradicate the need to manually update the look-up table, e.g., in case of a failover. Floating IP refers to a flexible IP address that tray be attached/detached from any machine and which may be reassigned or reused. Floating IP is provided by a public network, e.g., in an infrastructure-as-a-service (IaaS) setup. Usually, there is a floating IP pool within the public network which stores all available floating IPs. A floating IP may be assigned to a machine and if later the machine is down, the floating IP may be detached from the machine and the same floating IP may be reassigned to another machine so that the requests pertaining to the floating IP may he automatically handled by the another machine. However, as the floating IP is provided by the public network, it can be hacked and used to retrieve sensitive or private data stored in the machine database associated with the floating IP. Therefore, the privacy of data might be at risk.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram illustrating various components within a private network for handling floating internet protocol (FIP), according to an embodiment.

FIG. 2 is a block diagram illustrating a backend system comprising a database and its instances operating in a master slave mode, according to an embodiment.

FIG. 3 is a block diagram illustrating a user accessing a private network through an application, according to an embodiment.

FIG. 4 is a block diagram illustrating various components for handling floating internet protocol (FIP) within multiple private networks, according to an embodiment.

FIG. 5 is a flowchart illustrating a process of handling floating internet protocol (FIP) within a private network, according to an embodiment.

FIG. 6 is a flowchart illustrating a process of attaching/detaching floating internet protocol (FIP) within a private network, according to an embodiment.

FIG. 7 is a block diagram illustrating an exemplary computer system, according to an embodiment.

### DESCRIPTION

Embodiments of techniques for floating internet protocol (IP) for private networks are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

“Device” refers to a logical and/or a physical unit adapted for a specific purpose. The device may include any real world object or things which can be analyzed, observed, or monitored. Device encompasses, but is not limited to, a communication device, a computing device, a handheld device, and a mobile device such as an enterprise digital assistant (EDA), a personal digital assistant (PDA), a tablet computer, a smartphone, a vehicle, a machine, an engine, a smart device, for example smart watches or glasses, and the like. The device can access internet services such as World Wide Web (www) or electronic mails (E-mails), and exchange information with another device or a server.

“Internet protocol (IP) address” refers to a numerical label assigned to a device (e.g., computer, printer, router, database, database instance, standby database, etc.) participating in a network that uses the IP communication. Each device has an IP address that uniquely identifies it from all other devices on the internet. An IP address helps in identification of device and its location. The IP has the task of delivering packets from the source to the destination solely based on the IP addresses.

“Private network” refers to network which provides internal network access to various machines, databases, and/or their instances. The private network may be secured and isolated from other private networks, public networks, and/or interact. The private network may be accessed through its private internet protocol (IP) address. The private network may also be referred as “tenant network.”

“Backend system” refers to various databases, machines, and data processing components which provides responses to requests generated through front-end systems, web applications, graphical user interfaces, etc. In other words, the back-end system provides responses to requests generated from the front end systems. The backend system stores private and sensitive data and needs to be protected, isolated, and/or secured from external network (other private and/or public network) and internet. The backend system may be accessed through an application, e.g., the web application, the cloud application, etc., or through a backend services.

“Application” refers to a software or a set of computer programs that are executed to perform various functions. For example, an application may be executed to retrieve data from backend systems including database, etc. The application may be interactive, i.e., have a graphical user interface through which a user can query, modify, and input data and also analyze retrieved data instantaneously. The application hosted on cloud may he termed as “cloud application.” The “cloud application” helps a user to query, modify, and analyze the collected or stored data. Each application is associated with or tied to a backend system (e.g., a machine or a database) which handles all the requests through that application.

“Failover” refers to a procedure by which when a system (e.g., a backend system or database) fails, the control is automatically transferred to a duplicate system (e.g., a duplicate database, a standby database, or a database instance). Therefore, the failover is a backup operational mode in which the functions of a system (including a processor, server, network, or database, etc.) are performed by secondary system a duplicate database or a database instance) when the primary system becomes unavailable through either a failure, an abnormal termination, or a scheduled down time.

“Floating IP address” or “FIP address” refers to an IP address which may be reassigned from one device to another. The FIP address is not permanently fixed to a machine or a device. The FIP address may be assigned/reassigned to different devices, if required. For example, if device1 is allotted or assigned a FIP address to handle all requests pertaining to that FIP and later if the device1 cannot handle the request (e.g., due to technical issues), the same FIP may be reassigned to device2 so that the requests pertaining to that FIP address may then be handled by device2. Therefore, FIP address can be instantly moved from one device to another.

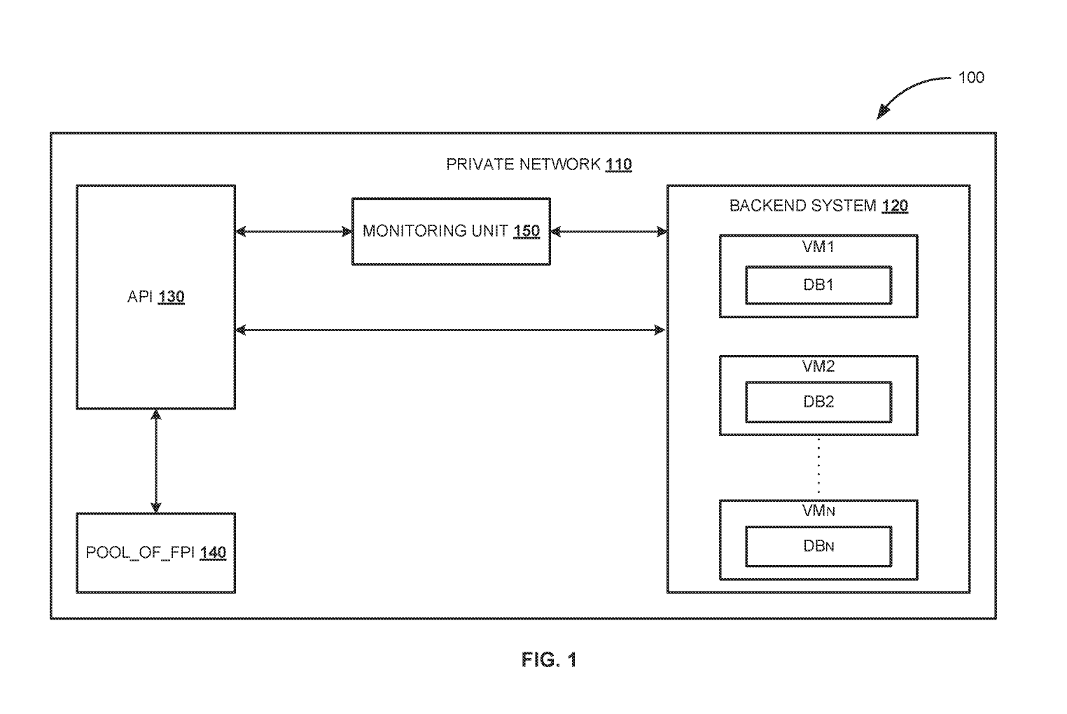

FIG. 1 is a block diagram illustrating exemplary system 100 for handling floating internet protocol (FIP) within a private network 110, according to an embodiment. The private network 110 may handle data related to a private entity, e.g., an enterprise. The private network 110 may include backend system 120 to handle and store private data. The backend system 120 may comprise one or more components, e.g., virtual machines (VM1-VMn) including respective databases (DB1-DBn). In an embodiment, the virtual machines VM2-VMn and the databases DB2-DBn may be instances of the virtual machine VM1 and the database DB1, respectively. Each component (e.g., the virtual machines and/or their instances) may have their respective permanent or fixed internet protocol (IP) address which identifies the component. One or more floating IP (FIP) addresses may also be allotted or assigned to the virtual machines and their instances (e.g., the virtual machines VM1-VMn). An FIP address may be assigned through API 130. The API 130 communicates with pool_of_FIP 140. The pool_of_FIP 140 includes one or more available floating IPs (FIPs) which may be allotted to one or more machines or databases. In one embodiment, the pool_of_FIP 140 may reside on other private network. The API 130 may requests a FIP from the pool_of_FIP 140 and the pool_of_FIP 140 may provide an available FIP address (e.g., 10.1.1.14) to the API 130. The API 130 may attach the received FIP address (10.1.1.14) to the required machine or database (e.g., VMn). The API 130 may attach the FIP address using an attach function, e.g., “attach(FIP: 10.1.1.14 to VMn)”. Next, any request for the FIP address 10.1.1.14, is handled by the virtual machine VMn. The virtual machines handling the request for their respective FIP address may he monitored. The virtual machines (VM1-VMn) may be monitored by monitoring unit 150. The monitoring unit 150 keeps track of the virtual machines (VM1-VMn) and their respective databases (DB1-DBn). In case of failure of any machine or database, the monitoring unit 150 informs the API 130. The API 130 identifies the FIP address attached to the failed machine (e.g., VMn) and detaches the identified FIP address from the failed machine or database. The API 130 may detach the FIP address using a detach function, e.g., “detach (FIP: 10.1.1.14 from VMn)”. The API 130 may identify another machine (e.g., VM2) which may handle the tasks of the failed machine (VMn) and attach the FIP to the machine VM2 through attach function, e.g., “attach(FIP: 10.1.1.14 to VM2)”. In an embodiment, the API 130 inquires the monitoring unit 150 to identify another available machine to resume the task of the failed machine and the monitoring unit 150 provides the lists of available machines to the API 130, the API 130 may then attach the FIP to one of the available machines, e.g., VM2, so that the requests or tasks for the FIP may then be handled by the machine VM2. Therefore, the FIP is derived, managed, and handled within the private network 110 itself.

The private network provides internal network access for various components (e.g., devices, machines, their instances, etc.) within the private network. The private network may be secured and may be accessed through its private IP. The components within the private network may include various private and sensitive data and needs to be protected. Usually, the private data related to the components may be stored and maintained in a backend system within the private network (e.g., the backend system 120 within the private network 110 of FIG. 1). In an embodiment, the backend system includes one machine or database and its various instances for handling, storing, arid managing private data. The machine and its instances and the database and its instances, within the backend system, may operate in a master-slave mode.

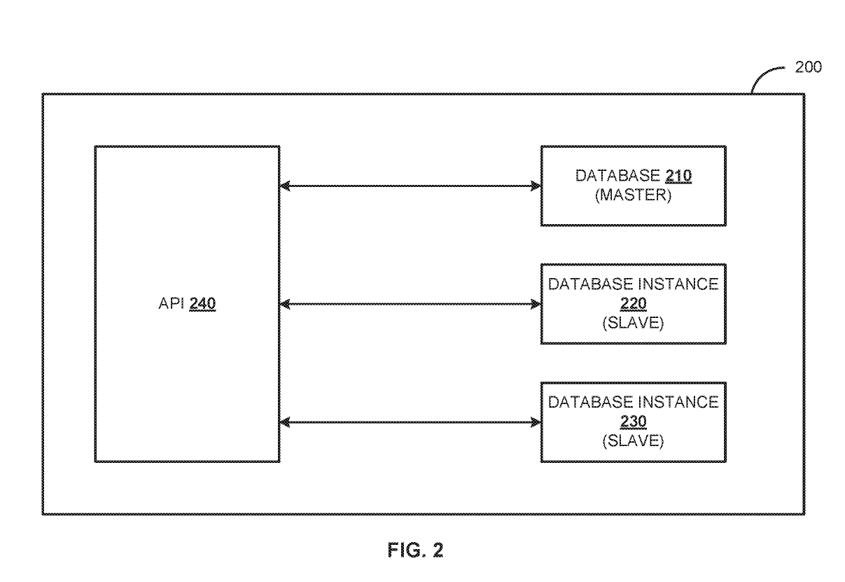

FIG. 2 is a block diagram illustrating a backend system 200 included in a private network (not shown), according to an embodiment. The backend system 200 includes a database 210 and its instances 220 and 230 to handle, store, and manage private data related to the private network. The database 210 and its instances 220 and 230 may operate in a master slave mode. The database 210 and its instances 220 and 230 may be identified through its permanent or fixed IP address. One or more FIP addresses can also be attached to the database 210 and its instances 220 and 230. For example, the FIP addresses 10.1.1.15 and 10.1.1.16 may be attached to the database 210 so that the requests for the FIP 10.1.1.15 and 10.1.1.16 may be handled by the database 210. The database 210 which handles the requests tray be termed as a master database. The database instances 220 and 230 may be standby databases which may be used when the master database 210 fails. The standby databases (e.g., the database instances 220 and 230) may be termed as slaves. When the master database 210 fails, the FIP addresses (10.1.1.15 and 10.1.1.16) may be detached from the database 210. One of the instances 220-230 of the master database 210 may be designated as master, e.g., the database instance 220 may be designated as master to resume the tasks of the failed database 210. The FIP addresses (10.1.1.15 and 10.1.1.16) is attached to the new master database, i.e., the database instance 220. The API may attach/detach, assign, or reassign, the FIP addresses to the database and its instances. For example, API 240 may detach the FIP addresses (10.1.1.15 and 10.1.1.16) from the failed database 210 and attach the FIP addresses (10.1.1.15 and 10.1.1.16) to the database instance 220 so that the requests or tasks related to the FIP addresses may be handled by the database instance 220.

The request or task for the backend system or databases may be generated and received through an application. The application (e.g., a web application or ecommerce website) may be launched by a private entity or owner of the private network. One or more applications may be launched by the private entity so that the required private data may be made available to the users. For example, a private entity (e.g., XYZ) may launch an application “xyz.com” which may be accessed by the users from other external or public network to purchase items or create request for purchase. Each application is configured to be associated with or served by a database (private backend system storing private data). The application “xyz.com” is associated with XYZ backend system (database) storing private data. The request (e.g., show all cloth items) may be created through the application (xyz.com) and the database (XYZ) may retrieve and provide necessary data (all cloth items) to the user.

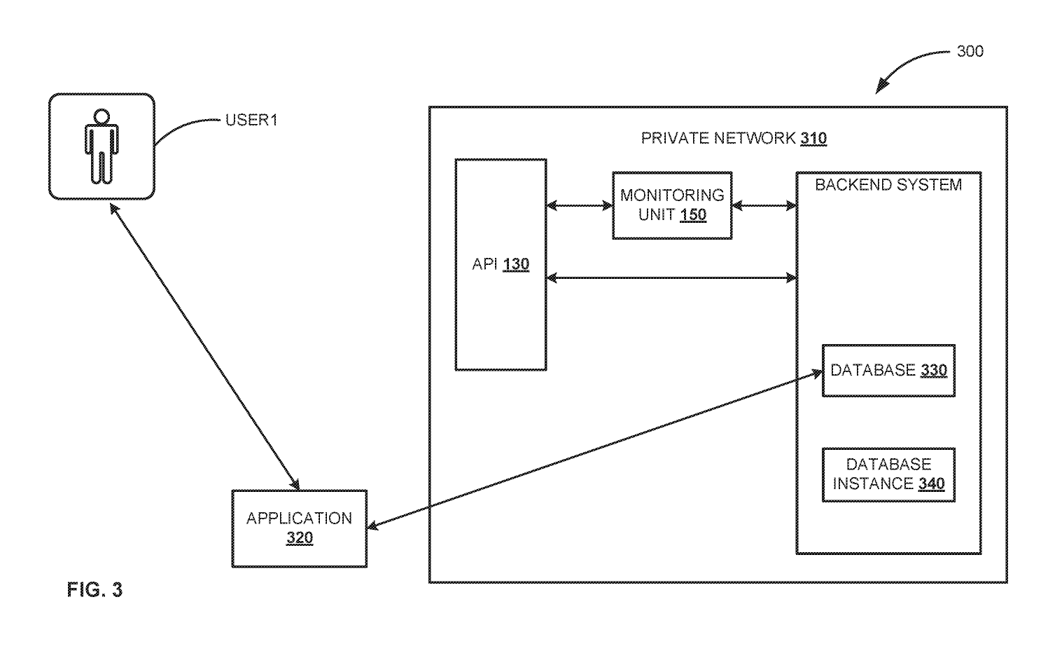

FIG. 3 is a block diagram of exemplary system 300 illustrating a user (user1) accessing private network 310 through application 320, according to an embodiment. The application 320 may be launched by a private entity, i.e., the owner of the private network 310. The application 320 may be specific to an enterprise and may be designed for one or more purpose or tasks to serve users. For example, an ecommerce web application (e.g., deployed on cloud) may be designed for users to purchase items. The application 320 may be accessed from anywhere. The application 320 may be accessed by one or more users, e.g., User1. The user can place requests through the application 320. The web application (e.g., application 320) may be preconfigured to he served by a database with a particular FIP address (e.g., 10.1.1.17). Further, assume that the database 330 has the FIP address 10.1.1.17, then the database 330 will handle the requests from the application 320. For example, the application 320 may communicate with the database 330 to retrieve the data requested by the user1. In case of a failure of the database 330, the monitoring unit 150 informs the API 130 and the API 130 detach the FIP address (10.1.1.17) from the database 330 and attach it to the database instance 340. Now, the requests through the application 320 will be served by the database instance 340 as the FIP address 10.1.1.17 is assigned or attached to the database instance 340.

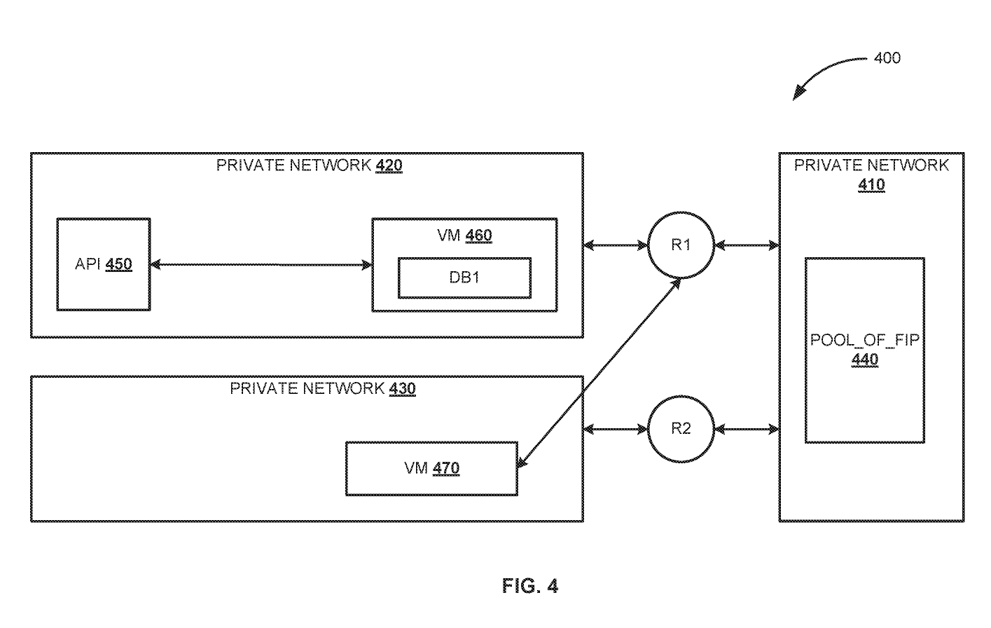

FIG. 4 is a block diagram of an exemplary system 400 that handles floating interact protocol (FIP) across multiple private networks 410-430, according to an embodiment. One of the private networks, e.g., the private network 410 may be configured as a private provider network to exclusively provide FIP addresses to other private networks. The private provider network (e.g., the network 410) may be used by other private networks 420-430 to derive FIP. In an embodiment, the private provider network may be termed as an FIP network. The FIP network or the private network 410 maintains pool of FIP 440. The pool of FIP 440 stores available FIP addresses that may be assigned to any private machine within any private network. If FIP address assigned to any machine on any other network is not in use, the network (API within that network) may detach the FIP address from the unused machine and may return back the FIP address to the private provider network 410 so that it can be stored back in the pool_of_FIP 440 and can be reused or reassigned to some other machine. The network 410-430 may communicate with each other through routers. For example, the network 420 communicates with the private provider network 410 through a router R1 and the network 430 communicates with the private provider network 410 through a router R2. The routers may be logical and/or physical unit. A router may have an IP address as its identifier.

In an embodiment, the routers may be configured with network address translation (NAT) rule. For example, the router R1 may be configured with NAT rule which maps FIP addresses with their corresponding machine or database, i.e., the machine or database which is attached to the FIP address. Suppose, the private network 420 has derived an FIP address (10.0.1.13) from the private provider network 410 and attached this FIP address 10.0.1.13 (e.g., through API 450) to virtual machine VM 460 including a database DB1 and having a fixed IP 10.0.0.17, then the router R1 may be configured as:

| Floating IP | IP of Virtual Machine |
|---|---|
| 10.0.1.13 | 10.0.0.1 |

Based upon the above NAT rule, the router R1 forwards all traffic for FIP address 10.0.1.13 to the VM 10.0.0.17. In an embodiment, the router R1 is required to be first configured with gratuitous ARP for 10.0.1.13. Gratuitous ARP is an address resolution protocol. Configuring with gratuitous ARP for 10.0.1.13 indicates that all traffic destined for the FIP address 10.0.1.13 is to be first received at the router R1.

In an embodiment, when a component of other private network (e.g., the virtual machine 470 of the private network 430) tries to invoke the database DB1 of the private network 420 (i.e., the VM 460 with IP 10.0.0.17 and FIP 10.0.1.13), the call is routed to the router R1. Once the call is received at the router R1, the router R1 applies NAT rule and determines that it has to be served by the virtual machine 10.0.0.17 of the private network 420. The call or request is then forwarded to the virtual machine with IP 10.0.0.17 and the target VM 460 or database DB1 is invoked.

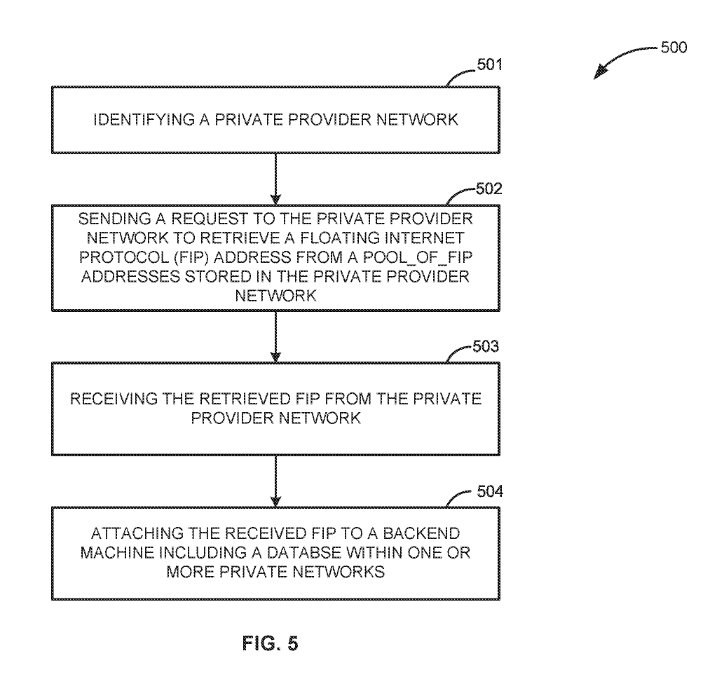

FIG. 5 is a flowchart illustrating a process 500 to handle a floating IP within a private network (e.g., the private network 110 of FIG. 1), according to an embodiment. At 501, a private provider network is identified. The private provider network provides one or more floating internet protocol (FIP) addresses to one or more external networks. At 502, a request is sent to the identified provider network for retrieving a floating internet protocol (FIP) address. The provider network may be another private network which includes or stores a pool of FIP addresses from where an FIP address may be retrieved randomly or based upon an algorithm. The retrieved FIP address may then be provided to the requesting private network or the API of the private network. At 503, the FIP address is received from the provider network. Once the FIP is received from the provider network, the private network (e.g., the API 130 of the private network 110) may attach the received FIP address to a backend machine included within the private network, at 504. The FIP may be attached using an attach function, e.g., attach(FIP address, backend machine identifier or ID). The backend machine ID may be a permanent or fixed IP of the backend machine. The backend machine may comprise a database and its instances. The backend machine tray then be accessed using the attached FIP address.

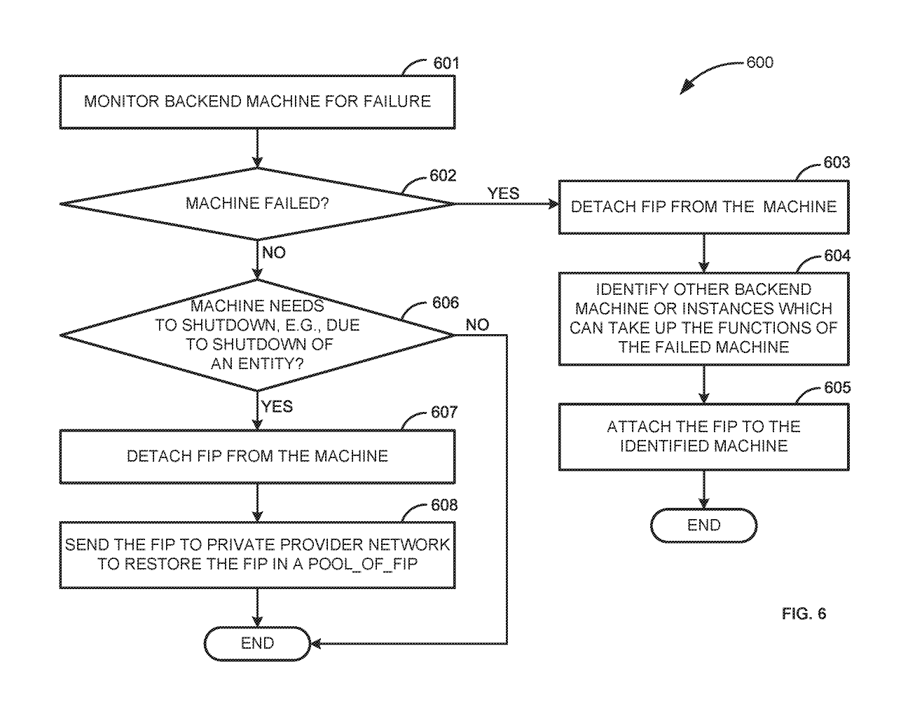

FIG. 6 is a flowchart illustrating a process 600 to attach/detach floating IP address within a private network (e.g., the private network 110 of FIG. 1), according to an embodiment. The private network includes backend machines or databases. The backend machines or databases may be monitored for failure. At 601, the backend machine may be monitored. At 602, it is determined whether the backend machine has failed. If the backend machine is failed (602: YES), then one or more FIP addresses may be detached from the backend machine at 603. In an embodiment, the failure may be due to technical and/or nontechnical faults. The FIP may be detached from the failed backend machine, e.g., using a detach function: detach(FIP address of the failed backend machine, ID of the failed backend machine). At 604, another backend machine or instances of the failed machine is identified which may handle the functions or tasks of the failed backend machine. At 605, the FIP address may be attached to the identified another machine so that all the functions or tasks of the failed machine may be resumed by the identified machine. In an embodiment, if the backend machine has not failed (602: NO), it may be determined, at 606, if the backend machine needs to be terminated, e.g., due to shutdown of an entity and/or termination of application which the backend machine was supporting. If the backend machine needs to be terminated (606: YES), the FIP of the backend machine may be detached at 607. At 608, the detached FIP address is sent to the private provider network so that it can be included back in the pool_of_FIP.

Embodiments enable decoupling floating IP from the public network or internet. The floating IP (FIP) is derived from a pool_of FIP provided or included within the private or tenant network. As the FIP is derived from (private or tenant-specific FIP pool) within the private network, it cannot be hacked or exposed to the public network, other external network, or internet. Therefore, floating IP derived and used from within the private network (i.e., private FIP) is secured. The backend systems (e.g., message brokers, databases, etc.) within the private network may be allotted private FIP (i.e., FIP derived from the private network) so that their FIP may not be exposed or accessed from the external network or internet and the data stored in the backend system may be secured. The failover for backend systems may also be managed using private FIP without exposing the backend systems and their sensitive or private data to the external network. The concept of deriving the floating IP from within the private network, e.g., for handling failover, is, therefore, secured. Further, it restricts access to backend systems or private data (e.g., SaaS OpenStack data) from public network or internet.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

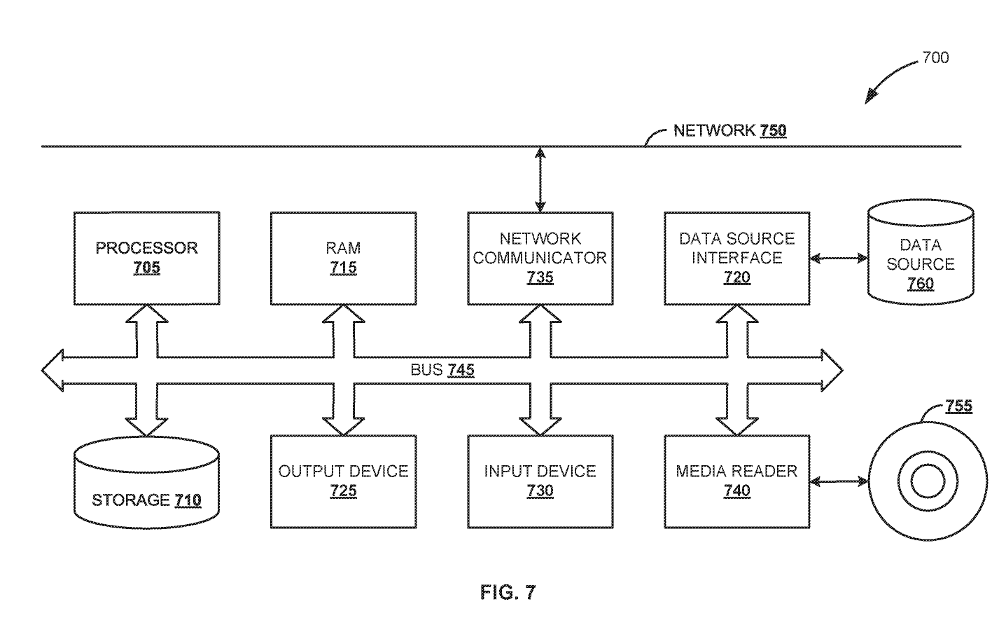

FIG. 7 is a block diagram of an exemplary computer system 700. The computer system 700 includes a processor 705 that executes software instructions or code stored on a computer readable storage medium 755 to perform the above-illustrated methods. The processor 705 can include a plurality of cores. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. According to some embodiments, such as some in-memory computing system embodiments, the RAM 715 can have sufficient storage capacity to store much of the data required for processing in the RAM 715 instead of in the storage 710. In some embodiments, the data required for processing may be stored in the RAM 715. The stored instructions may be further compiled to generate other representations of the instructions and dynamically stored in the RAM 715. The processor 705 reads instructions from the RAM 715 and performs actions as instructed. According to one embodiment, the computer system 700 further includes an output device 725 (e.g., a display) to provide at least some of the results of the execution as output including, but not limited to, visual information to users and an input device 730 to provide a user or another device with means for entering data and/or otherwise interact with the computer system 700. The output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer-readable medium to store instructions, which when executed by a computer, causes the computer to:
identify a provider network, wherein the provider network is a private network and provides one or more floating interact protocol (FIP) addresses to one or more backend machines of one or more external networks;
based upon the identification, send a request to the provider network for retrieving an FIP address from a plurality of FIP addresses stored in the provider network;
receive the FIP address from the provider network; and
attach the received FIP address to a backend machine of the one or more backend machines including a database to handle requests generated for the FIP address.

2. The non-transitory computer readable medium of claim 1 further stores instructions which when executed, causes the computer to:
monitor the backend machine to identify failure;
upon detecting the failure, detach the FIP address from the backend machine;
identify one or more other available backend machines to handle the requests generated for the FIP address; and
attach the FIP address to one of the identified one or more other available backend machines.

3. The non-transitory computer readable medium of claim 2, wherein the failure comprises at least one of a technical and a non-technical fault and wherein upon detecting the failure, a detach function is invoked through an application programming interface of an external network to detach the FIP address from the backend machine of the external network.

4. The non-transitory computer readable medium of claim 1, wherein the backend machine is accessed through an application.

5. The non-transitory computer readable medium of claim 4 further stores instructions which when executed, causes the computer to:
identify one or more requests received through the application;
determine the FIP address associated with the application;
identify the backend machine associated with the FIP address; and
route the one or more requests to the determined backend machine.

6. The non-transitory computer readable medium of claim 5, wherein the one or more requests is received from the one or more external network and wherein the one or more requests from the one or more external network is received at a router connecting the backend machine and the provider network.

7. The non-transitory computer readable medium of claim 6, wherein the router is a logical router.

8. The non-transitory computer readable medium of claim 1, wherein the backend machine further comprises one or more instances of the database.

9. A computer-implemented method for handling floating internet protocol (FIP) within private networks, the method comprising:
identifying a provider network, wherein the provider network is a private network and provides one or more floating internet protocol (FIP) addresses to one or more backend machines of one or more external networks;
based upon the identification, sending a request to the provider network for retrieving an FIP address from a plurality of FIP addresses stored in the provider network;
receiving the FIP address from the provider network; and
attaching the received FIP address to a backend machine of the one or more backend machines including a database to handle requests generated for the FIP address.

10. The method of claim 9 further comprising:
monitoring the backend machine to identify failure;
upon detecting the failure, detaching the FIP address from the backend machine;
identifying one or more other available backend machines to handle the requests generated for the FIP address; and
attaching the FIP address to one of the identified one or more other backend machines.

11. The method of claim 9 further comprising:
identifying one or more requests received through an application configured to access the backend machine associated with the FIP;
determining the FIP address associated with the application;
based upon the identified FIP address, determining the backend machine associated with the FIP address; and
routing the one or more requests to the determined backend machine.

12. A computer system comprising:
at least one memory to store executable instructions; and
at least one processor communicatively coupled to the at least one memory, the at least one processor configured to execute the executable instructions to:
identify a provider network, wherein the provider network is a private net work and provides one or more floating internet protocol (FIP) addresses to one or more backend machines of one or more external networks;
based upon the identification, send a request to the provider network for retrieving an FIP address from a plurality of FIP addresses stored in the provider network;
receive the FIP address from the provider network; and
attach the received FIP address to a backend machine of the one or more backend machines including a database to handle requests generated for the FIP address.

13. The system of claim 12, wherein the controller is further configured to:
monitor the backend machine to identify failure;
upon detecting the failure, detach the FIP address from the backend machine;
identify one or more other available backend machines to handle the requests generated for the FIP address; and
attach the FIP address to one of the identified one or more other available backend machines.

14. The system of claim 13, wherein the failure comprises at least one of a technical and a non-technical fault and wherein upon detecting the failure, a detach function is invoked through an application programming interface of an external network to detach the FIP address from the backend machine of the external network.

15. The system of claim 12, wherein the backend machine further comprises one or more instances of the database.

16. The system of claim 12, wherein the backend machine is accessed through an application.

17. The system of claim 16, wherein the controller is further configured to:
identify one or more requests received through the application;
determine the FIP address associated with the application;
based upon the identified FIP address, determine the backend machine associated with the FIP address; and
route the one or more requests to the determined backend machine.

18. The system of claim 17, wherein the one or more requests is received from one or more external network and wherein the one or more requests from the one or more external network is received at a router.

19. The system of claim 18, wherein the router connects the backend machine to the provider network.

20. The system of claim 18, wherein the router is a logical router.
